(19) United States
(12) Patent Application Publication
(10) Pub. No.: US 2026/0195781 A1
(43) Pub. Date: Jul. 9, 2026

(54) System

(71) Applicant: Softbank Group Corp., Tokyo (JP)

(72) Inventor: Makoto Iimura, Tokyo (JP)

(21) Appl. No.: 19/434,987

(22) Filed: Dec. 29, 2025

(30) Foreign Application Priority Data
Jan. 7, 2025 (JP) 2025-002219

(51) Int. Cl. G06Q 30/0201; G06Q 10/0635

(52) U.S. Cl. CPC G06Q 30/02017; G06Q 10/0635

(57) ABSTRACT

A system includes a processor that retains market-related information or business-related information, generates a prompt sentence that instructs generation of strategic information concerning establishment or growth of a business entity based on the market-related information or business-related information stored in the information retaining means, inputs the prompt sentence to a generative AI model that performs natural language processing and acquires at least one of new business proposal information, progress management information, funding support information, sales promotion information, development process improvement information, or risk avoidance information for the business entity from the generative AI model, and presents the information acquired by said generation means to a user.

### CROSS-REFERENCE TO RELATED APPLICATION

This application is based on and claims priority under 35 USC 119 from Japanese Patent Application No. 2025-002219 filed on January 7, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, business entities have required increasingly advanced and dynamic strategic information to establish successful new ventures or to promote sustainable growth. However, conventional systems often require significant time and labor to collect, analyze, and synthesize vast amounts of market-related and business-related data for strategic planning. There is also a need for a mechanism that can flexibly generate various forms of strategic information, such as new business proposals, progress management, funding support, sales promotions, development improvements, and risk avoidance, in response to specific user demands. Existing solutions frequently lack the ability to efficiently leverage up-to-date information and utilize advanced AI models capable of providing concrete, actionable strategies tailored to each situation.

### SUMMARY

To address these issues, the present invention provides a system comprising a processor that retains market-related or business-related information and generates, based on such information, a prompt sentence for instructing a generative AI model to create strategic information regarding business establishment or growth. The processor inputs this prompt sentence into a generative AI model capable of natural language processing and acquires at least one of new business proposal information, progress management information, funding support information, sales promotion information, development process improvement information, or risk avoidance information from the generative AI model. The processor then presents the generated information to the user. Furthermore, the processor can include trend-related information in the prompt to facilitate the generation of sales promotion strategies, and can also extract potential factors from retained information to refine prompts in order to generate effective risk avoidance tactics.

"market-related information" means that information pertaining to external market conditions, trends, customer preferences, competitor activities, and other data relevant to the overall market environment of a business entity.

"business-related information" means that information concerning the internal status, plans, progress, organization, financial condition, or operational details of a specific business entity.

"information retaining means" means that a hardware or software component configured to store and manage market-related information or business-related information for subsequent processing.

"prompt generation means" means that a hardware or software module configured to generate a prompt sentence, based on stored information, for instructing a generative AI model to produce desired strategic information.

"prompt sentence" means that a natural language instruction, including information and requirements, provided to a generative AI model to obtain specific outputs.

"generative AI model" means that a machine learning model, such as a large language model, capable of generating natural language responses or strategic information in accordance with an input prompt.

"generation means" means that a hardware or software module configured to input the prompt sentence into a generative AI model and to receive the outputted information from the model.

"user" means that an operator, employee, or person who interacts with the system to request, receive, or review strategic information.

"strategic information" means that information generated by the generative AI model, including but not limited to new business proposal information, progress management information, funding support information, sales promotion information, development process improvement information, or risk avoidance information.

"trend information" means that data or analytical output reflecting changes, movements, or tendencies observed in market-related information over time.

"potential factor" means that any element or condition identified within market-related or business-related information that may contribute to risk or require mitigation strategies for business planning.

"risk avoidance information" means that information or recommendations aimed at identifying, mitigating, or managing risks within a business context, as generated by the generative AI model based on relevant factors.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

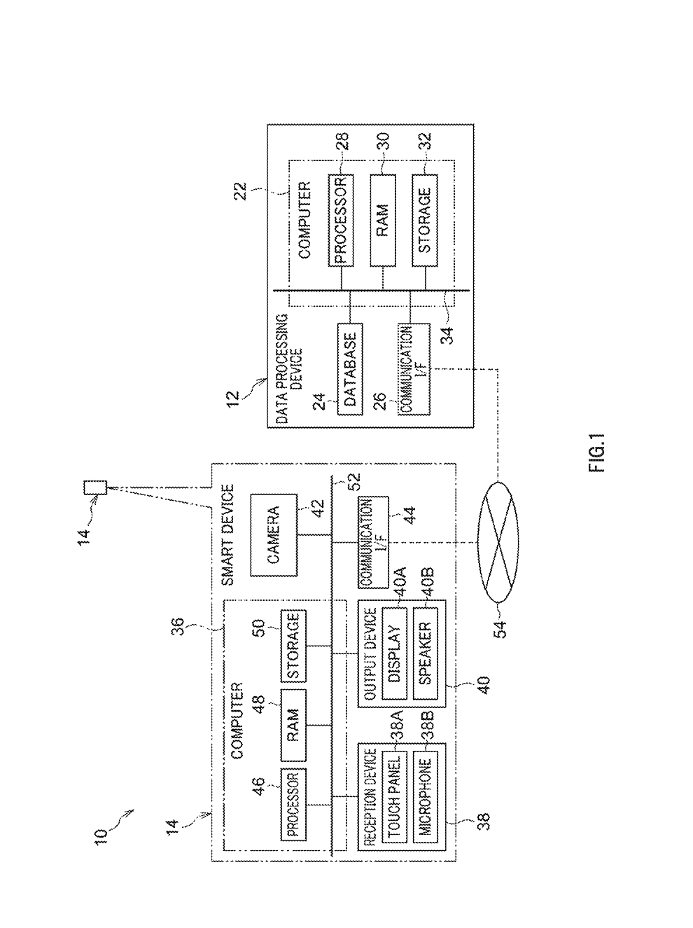

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

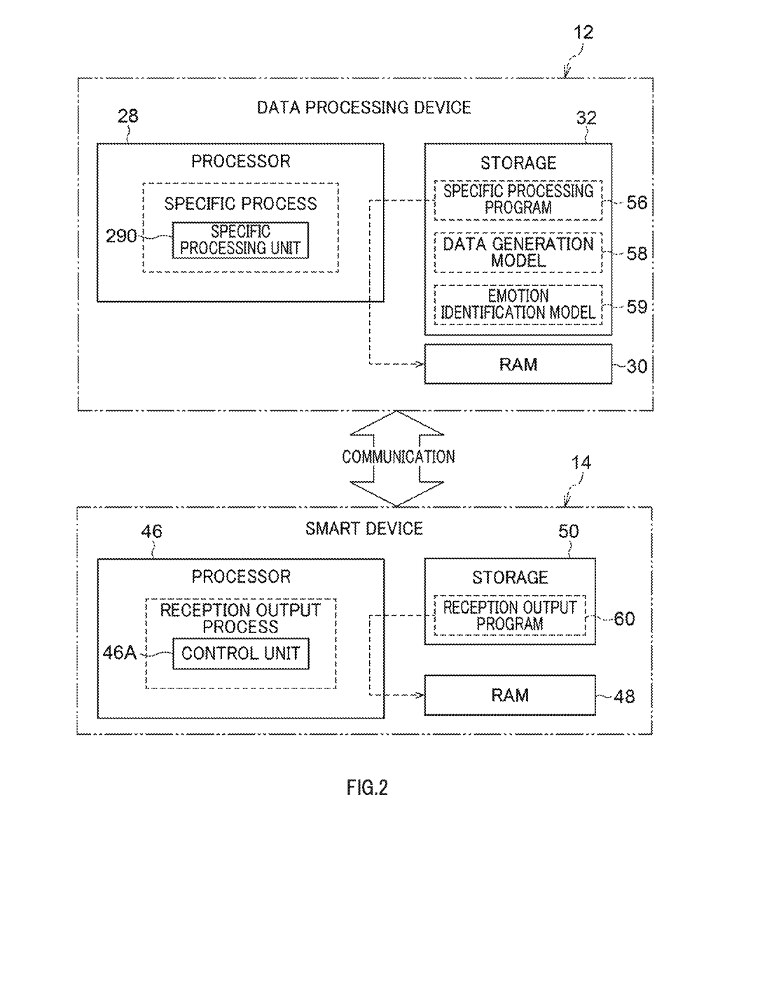

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In business development, particularly in the establishment and growth of enterprises, it is crucial to efficiently generate, evaluate, and improve strategic information such as new business proposals, project management guidelines, funding support suggestions, sales promotion strategies, development process enhancements, and risk mitigation plans. However, conventional systems frequently lack integrated mechanisms that seamlessly connect relevant information storage, dynamic generation of natural language input for generative AI models, iterative interaction with users, and effective utilization of accumulated dialogue history. This results in inefficiencies, insufficient contextual adaptation, and increased operational burden for users who must manually interpret and merge various information sources to make strategic decisions. Therefore, there is a need for a comprehensive support system capable of automatically processing and integrating multiple data sources and user requests, generating contextually suitable prompt sentences, leveraging generative AI models, and providing user-adaptive, iterative strategic suggestions in a user-friendly manner.

The specific processing by the specific processing unit 290 of the data processing device 12 in Example 1 is realized by the following means.

The present invention provides a server comprising an information storage unit, a prompt sentence generation unit configured to automatically generate prompt sentences based on the stored information for use with a generative machine learning model, a generative response acquisition unit configured to transmit the prompt sentence to the generative machine learning model and process received responses into structured data or display information, an interaction history management unit configured to manage and utilize multiple user requests and generated responses to facilitate context-aware repeated querying, and a terminal support unit configured to process user requests, deliver dynamic response information, and facilitate interactive display and input support via a terminal device. This enables integrated, adaptive, and iterative strategic information generation and presentation to users in response to their business development needs, while efficiently leveraging accumulated history and underlying business data.

The term “information storage unit” refers to a data storage device or system that is configured to retain, manage, and provide access to various types of information, including but not limited to market-related data, business-related data, user inputs, and interaction histories.

The term “generative machine learning model” refers to an artificial intelligence model capable of processing natural language prompt sentences and generating coherent, context-relevant responses using previously trained data, including but not limited to large language models or natural language generation models.

The term “generative response acquisition unit” refers to a functional component or software module that transmits the prompt sentence to the generative machine learning model, retrieves the generated response, and transforms the response into structured data or displayable information.

The term “user request” refers to an operation or inquiry submitted by a user through a terminal device, specifying desired information, guidance, or strategic advice to be obtained by the system.

The term “terminal device” refers to an electronic interface or computing device through which a user interacts with the system, including but not limited to personal computers, mobile devices, tablets, or any display and input-enabled apparatus.

The term “interaction history management unit” refers to a functional component or software module that records, manages, and utilizes a sequence of user requests and generated responses to support iterative and context-aware information processing and repeated querying.

The term “terminal support unit” refers to a functional component or software module, operating on the terminal device, that facilitates the transmission and reception of information, dynamic display of results, and processing of user interactions and inputs.

The term “structured data” refers to information arranged in a predefined and machine-readable data format, such as JSON, XML, or tabular form, suitable for systematic processing, storage, or display.

The term “display information” refers to any formatted data or visual presentation generated by the system for rendering on a terminal device to be easily understood by the user.

The embodiment for implementing the invention is described below. The present invention may be realized as an integrated information processing system comprising a server and at least one terminal device, both of which include the components and functionalities claimed. The server is configured as a computer system equipped with a processor (such as a multi-core CPU), memory (RAM), storage device (such as SSD or HDD), and network interface, operating under an operating system such as Linux, UNIX, or Windows Server. The server executes server-side programs developed in languages such as Python and operates application frameworks such as FastAPI or Flask for handling API endpoints. The server further uses a data management system such as PostgreSQL or MySQL to realize the information storage unit for persisting market data, business data, and interaction history. The information storage unit holds various types of information, including but not limited to market trends, business plans, customer profiles, competitor data, project progress and organizational structures. A database management system is used to appropriately store and retrieve such information.

The prompt sentence generation unit is implemented as a program running on the server that retrieves and interprets relevant information from the information storage unit. The server transforms this data into appropriately structured natural language sentences, for example, using a template engine such as Jinja2. The server constructs prompt sentences suitable for input to a generative machine learning model. The prompt sentence may include context, numerical data, or attribute information related to the business scenario. For illustration, a generated prompt sentence could be:

"Based on the following market data, propose three innovative HealthTech business ideas for millennials. Market data: Trend: demand for remote health consults; Competitors: Company A, Company B; Customer segment: Millennials."

The generative response acquisition unit transmits the generated prompt sentence via HTTP(S) to an external or internal generative AI model, such as a large-scale language model deployed on a cloud platform or on-premises server. The server manages authentication, request packaging, and result retrieval using HTTP and JSON-formatted messages. The server receives the AI-generated output, which may be in the form of a paragraph or list, and further parses, cleans, and structures this response before converting it into a format suitable for the terminal device, such as JSON or HTML.

The interaction history management unit records every user request and AI-generated response, updating the database accordingly. The server references this history when the user initiates additional or follow-up requests, enabling the system to provide contextually relevant and consistent advice or strategy proposals.

The terminal device can be a general-purpose computing device, such as a personal computer, smartphone, tablet, or other user-operated information device equipped with input and output functionalities. The terminal device utilizes software such as a web browser (for example, Google Chrome or Mozilla Firefox) or a dedicated application developed with a frontend framework (such as React.js or Vue.js). The terminal device communicates with the server using HTTP(S), sending user inputs such as requests for strategy proposals and receiving responses to be displayed on a graphical user interface.

The terminal support unit implemented on the terminal device listens for user input events, sends requests to the server, receives the response, and transforms the structured data into dynamic UI elements, such as lists or cards. The user can review the proposals presented on the terminal device and submit new or refined queries as needed.

The user operates the terminal device by entering textual requests, for example:

"Show three new business ideas for millennial HealthTech."

The terminal device transmits this request to the server, and the server processes the request as described above. The server returns, for example, the following proposals to the terminal device, which are displayed to the user:

1. Virtual health platform for millennials

2. Mental wellness chatbot with AI-driven recommendations

3. Wearable integration system for holistic health management

The user can then enter a follow-up request, such as:

"Show possible risks for idea 2."

The server references the interaction history, generates an appropriately detailed context-aware prompt sentence - e.g.,

"Based on the previous output and current market data, provide a risk assessment for 'Mental wellness chatbot with AI-driven recommendations.'" - and transmits this new prompt, iteratively continuing the process.

The system may be configured to interface with, for example, cloud-based generative machine learning model APIs, or could utilize an on-premises inference engine powered by an accelerator, such as a graphics processing unit (GPU), depending on hardware capabilities. The server architecture is modular and scalable to support simultaneous user interactions and data storage growth.

In this embodiment, all core software and hardware components—including the server processor, storage device, network infrastructure, database management system, prompt generation program, generative response acquisition module, interaction history handler, and terminal device application—are integrated so that a user can seamlessly retrieve, generate, and refine strategic business information through an efficient, context-driven dialogue with the system. Prompt sentence construction, data retrieval, and iterative interaction processes are automated and optimized to significantly reduce the operational burden on users and enhance the quality of strategic decision-making in business planning.

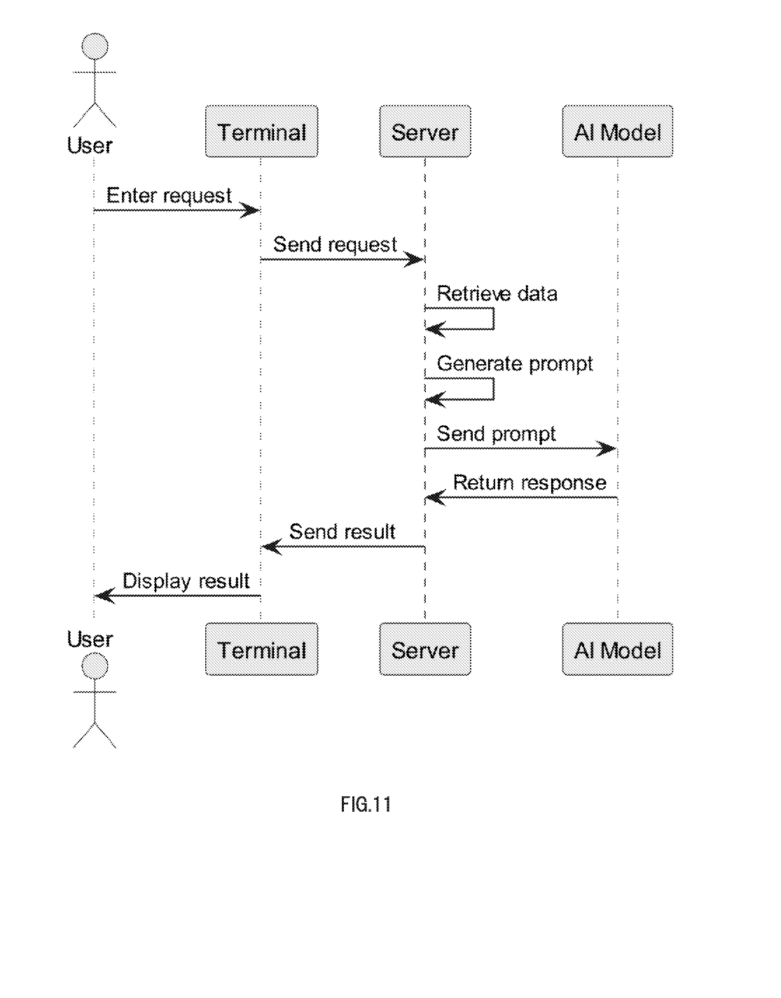

The following describes the processing flow using FIG. 11.

### Step 1:

User enters a request, such as “Show three new business ideas for millennial HealthTech,” into an input field on the terminal device interface.

Input: User’s textual request.

Output: Text data sent to the terminal’s input handler.

The user interacts with the graphical interface and triggers an event, for example by clicking a submit button.

### Step 2:

Terminal receives the textual request, formats it as a JSON object containing the user's request, and sends it to the server via an HTTP POST request.

Input: User’s textual request.

Processing: Terminal transforms user input into a structured JSON message and establishes an HTTP connection to the server endpoint.

Output: JSON-formatted request transmitted to the server.

### Step 3:

Server receives the JSON request and parses the user's request content.

Input: JSON-formatted data sent from the terminal.

Processing: Server extracts the relevant text, validates the request format, and logs the request for auditing.

Output: Parsed user request for further processing by the server.

### Step 4:

Server identifies necessary business and market information in its information storage unit according to the user’s request.

Input: Parsed user request.

Processing: Server uses SQL queries or equivalent data retrieval operations to fetch up-to-date and relevant business, market, or customer data from the database.

Output: Retrieved raw business data and related information.

### Step 5:

Server preprocesses, filters, and restructures the retrieved business and market data into a natural language format and generates a prompt sentence using a template engine.

Input: Raw business and market data.

Processing: Server removes irrelevant fields, normalizes the data, applies template processing (e.g., using a template engine), and integrates data into a natural language instruction.

Output: Fully constructed prompt sentence suitable for input to a generative AI model.

### Step 6:

Server sends the prompt sentence to a generative AI model, such as a large-scale language model, via an HTTP API call, and waits for the AI’s response.

Input: Constructed prompt sentence.

Processing: Server packages the prompt sentence into an API request, handles remote communication, and receives an AI-generated response.

Output: AI-generated response in natural language.

### Step 7:

Server processes the AI-generated response, parses the generated text, and converts it into a structured output such as a JSON object or display-ready text.

Input: AI-generated response text.

Processing: Server splits and organizes the output (such as splitting a paragraph into list items), sanitizes text, and structures it into a displayable data format.

Output: Structured data ready to send to the terminal device.

### Step 8:

Server sends the structured data back to the terminal device as an HTTP response.

Input: Structured output produced from the AI response.

Processing: Server formats and encodes the data, then establishes an HTTP response to the terminal.

Output: Structured response data transmitted over the network.

### Step 9:

Terminal receives the structured response, parses the data, and dynamically updates the graphical interface to display business ideas or other strategic information to the user.

Input: Structured response data from the server (such as a JSON array of business ideas).

Processing: Terminal parses JSON, generates UI elements (such as lists or cards), and updates the display accordingly.

Output: Visual presentation of AI-generated strategy information on the terminal device.

### Step 10:

User reviews the presented information and, if desired, inputs additional or follow-up requests, such as a query for risk analysis or request for further details.

Input: Visualized data and user understanding.

Output: New input or further refined user requests, initiating another cycle beginning with Step 1. The system enables iterative, interactive communication for optimizing business planning or decision-making.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In the fields of business development and startup support, there are significant challenges in efficiently generating and evaluating innovative business ideas, managing project progress, optimizing resource allocation, creating effective investor materials, and designing advertising and risk management strategies. Furthermore, conventional systems lack the ability to adapt their support and recommendations based on the emotional state of the user, resulting in insufficient personalization and responsiveness to user stress or motivation levels. Thus, there is a need for a comprehensive support system that can aggregate business and market information, leverage generative artificial intelligence models for strategic proposal generation, and provide adaptive, real-time feedback tailored to user context and emotions.

The specific processing by the specific processing unit 290 of the data processing device 12 in Application Example 1 is realized by the following means.

The present invention provides a server comprising a processor that stores business and market information, receives business concept information and emotional state information inputted by a user, generates prompt sentences for a generative artificial intelligence model based on stored information and user input, obtains business proposal and management information by inputting the prompt sentences into the generative artificial intelligence model, analyzes the user’s emotional state, and provides adaptive feedback and support to a client terminal in real time according to the results of emotion analysis. This enables real-time, personalized support for business innovation, project management, resource optimization, investor relations, advertising, and risk mitigation, effectively addressing both business needs and user emotional conditions.

The term “storage unit” refers to a data storage component or memory device used to retain business, market, and user-related information necessary for the operation of the system.

The term “business concept information” refers to information inputted by a user that includes initial business ideas, objectives, target markets, resource requirements, and other foundational aspects of a proposed or ongoing business activity.

The term “emotional state information” refers to information, either selected or described by a user, indicating the user’s current emotion, mood, or psychological status, such as stress, motivation, or satisfaction.

The term “input reception unit” refers to a hardware or software module configured to receive data, including business concepts and emotional state information, from a user via an interface such as a terminal or client device.

The term “market-related information” refers to data concerning current industry trends, consumer preferences, competitor activities, demand patterns, and other external market factors relevant to business planning and operation.

The term “business-related information” refers to data relating to the organization, progress, operations, or performance of a business entity, including project updates, resource allocation, and strategic plans.

The term “prompt sentence” refers to a natural language instruction or query generated by the system based on stored and inputted information, designed to elicit a relevant response from a generative artificial intelligence model.

The term “generative artificial intelligence model” refers to a computer-implemented model capable of processing natural language inputs and generating relevant and creative outputs, such as proposals or recommendations, through artificial intelligence techniques.

The term “new business proposal information” refers to output generated by the generative artificial intelligence model containing original business ideas, features, or opportunities suited to the user's input and market context.

The term “progress management information” refers to output or data relating to the tracking, assessment, and improvement of business or project progress, including timelines, milestones, and reporting.

The term “resource allocation optimization information” refers to recommendations or data generated by the system for effectively distributing or reallocating resources within a business or project based on dynamic conditions.

The term “funding support information” refers to information or proposals designed to assist the user in obtaining financial resources, such as investment pitches, potential investor lists, or funding strategies.

The term “advertising activity information” refers to recommendations or plans generated by the system concerning marketing campaigns, promotional activities, communication channels, or target demographics.

The term “development process improvement information” refers to suggestions or strategies for optimizing the processes, procedures, or methodologies involved in product or service development.

The term “risk avoidance information” refers to output identifying potential business risks and proposing specific mitigation strategies based on current business and market conditions.

The term “presentation unit” refers to a hardware or software component configured to display, transmit, or otherwise provide outputs and recommendations to a user terminal.

The term “terminal” refers to a client device, such as a smartphone, computer, or tablet, that allows a user to interact with the system for input and output.

The term “emotion analysis” refers to the process of examining the user’s emotional state information to influence or adjust the system’s responses and recommendations according to detected user emotions.

In one embodiment of the invention, the system consists of a server, a terminal, a user interface, a storage unit, a generative artificial intelligence model, and an emotion analysis module. The server is a computing device that may be implemented using standard cloud computing resources such as virtual machines on a public cloud platform. Examples include a virtual server instance running on cloud infrastructure provided by a generic cloud service provider. The terminal is a client device operated by the user, such as a smartphone, a tablet, or a personal computer, and communicates with the server via a network. The server is equipped with a processor and one or more storage units, which may be realized as relational or NoSQL databases. Commercially available database management systems, such as a general-purpose cloud database, can be used. The server executes software that comprises modules for receiving user input, generating prompt sentences, communicating with a generative artificial intelligence model, performing emotion analysis, and transmitting information to the terminal.

The user enters business concept information through the terminal’s user interface. This business concept information may include the user’s preliminary business ideas, target market, goals, and required resources. Additionally, the user may enter their current emotional state, which could be provided through a selection menu or a free-form text field representing states such as “motivation,” “stress,” or “anxiety.” The input interface may be implemented as a web application or a mobile application.

The terminal sends the captured business concept information and emotional state information to the server in a structured format, such as JSON transmitted over HTTPS. Upon receiving the input, the server stores relevant data in the storage unit. Next, the server analyzes the received user input and accesses related business and market information previously stored in the storage unit. To illustrate, the market information may consist of trend data, competitor activities, and consumer preference data obtained from web APIs or public data sources. The server then generates a prompt sentence for the generative artificial intelligence model. An example prompt sentence is as follows:

“Suggest three innovative features for a wearable healthcare device designed for elderly users in the US, based on the latest market trends and competitors.”

or

“Create an engaging investor summary for our IoT-based fitness tracker, highlighting market opportunities, unique features, and recent project milestones.”

The server transmits the prompt sentence to the generative artificial intelligence model via API. The generative artificial intelligence model, which can be implemented using large language models hosted by a generic artificial intelligence platform, receives the prompt sentence and generates output containing new business proposals, resource allocation strategies, investor presentation drafts, advertising activity plans, or risk avoidance suggestions.

The server then analyzes the output of the generative artificial intelligence model. In one example, the server scores and filters the output using rule-based or machine learning algorithms to ensure relevance and feasibility. The server further analyzes the user’s emotional state via the emotion analysis module. The module may utilize natural language processing techniques or neural network-based emotional classification models; a commercially available emotion detection API may be employed.

Using the result of emotion analysis, the server adjusts the presentation style or complexity of the information. For example, if the analysis indicates heightened user stress, the server simplifies recommendations and highlights specific, actionable steps. The server prepares the final output and transmits it to the terminal in real-time or near real-time.

The terminal presents the received information to the user through an application interface. The user may view suggested business ideas, investor presentation drafts, marketing strategies, or risk mitigation plans, and can request further information or clarification as needed. In these ways, the invention allows for real-time, adaptive business support that factors in both objective business context and the subjective state of the user, utilizing advanced generative artificial intelligence models and modern software architecture.

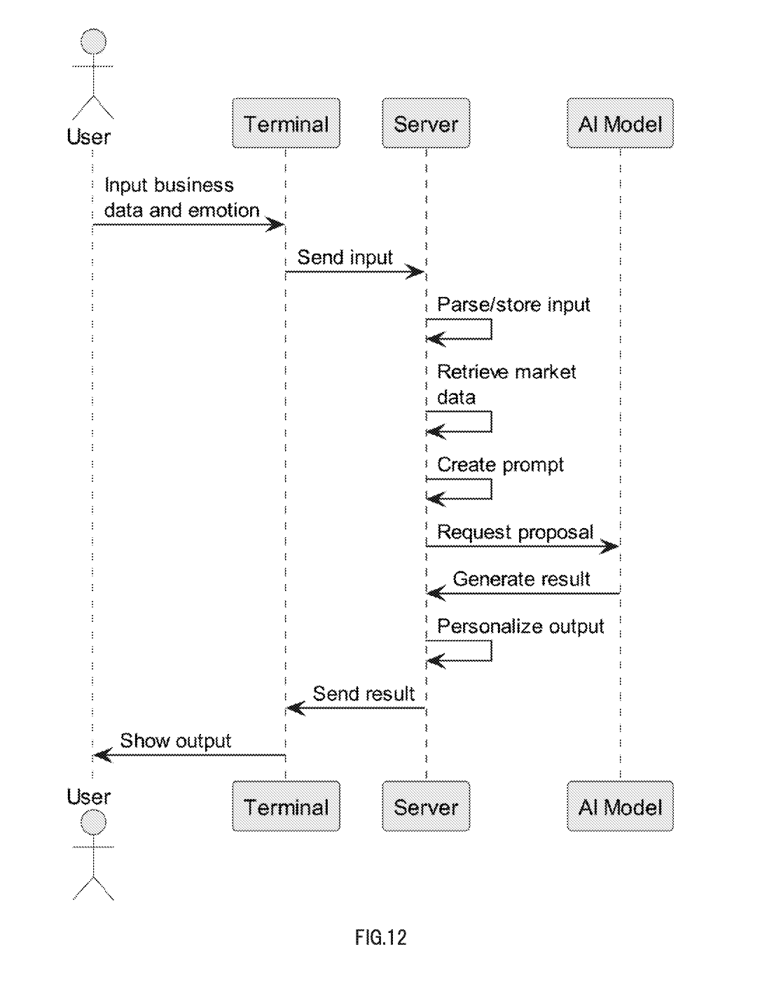

The following describes the processing flow using FIG. 12.

### Step 1:

The user operates the terminal to input business concept information, such as business ideas, target market, objectives, and required resources, through the application interface. The user may also enter emotional state information via a selection menu or text input. The input consists of structured data representing business attributes and emotional indicators. The output is a structured data set transmitted from the terminal to the server.

### Step 2:

The terminal receives the user input, encodes it into a structured format such as JSON, and securely transmits it to the server using HTTPS. The input for this step is the raw input data provided by the user. The output is a validated and securely transmitted data packet sent to the server.

### Step 3:

The server receives and validates the user input, then parses business concept and emotional state fields. The input is the structured data packet from the terminal. The server stores the parsed data in the storage unit for further processing. The output is updated storage records and parsed user context ready for analysis.

### Step 4:

The server analyzes the business concept information received from the user and retrieves related business and market information from the storage unit. The input is the user-provided concept and the stored business/market data. The server aggregates, filters, and summarizes relevant trend, competitor, and consumer data for the next processing step. The output is an enriched data set that combines user input with supplemental market information.

### Step 5:

The server constructs a prompt sentence for the generative AI model by combining the user’s business concept and emotional context with current market and business data. The input is the enriched data set and the parsed emotional state information. The output is a natural language prompt sentence formulated to elicit targeted responses from the generative AI model.

### Step 6:

The server sends the prompt sentence to the generative AI model via an API call. The input is the formatted prompt sentence. The generative AI model processes the prompt by performing natural language interpretation and content generation, producing outputs such as new business proposals, resource allocation strategies, investor document drafts, advertising plans, or risk mitigation advice. The output is the generated content delivered back to the server.

### Step 7:

The server receives and parses the output generated by the generative AI model. The input is the generated content from the AI model. The server may apply filtering, ranking, or scoring algorithms to prioritize responses, ensuring relevance and quality. The output is a set of actionable, ranked recommendations or reports tailored to the user’s business case.

### Step 8:

The server performs emotion analysis on the user’s emotional state information, utilizing an emotion classification module. The input is the latest user emotional data and the generative AI model output. The server adjusts the detail, tone, and order of presentation based on the emotion analysis—for example, making instructions simpler if the user is stressed. The output is a personalized set of recommendations, adapted to the user’s current emotional context.

### Step 9:

The server transmits the personalized, actionable information to the terminal. The input is the final, tailored recommendation set. The output is a data packet containing business proposals, supporting documents, and notifications sent to the terminal for user interaction.

### Step 10:

The terminal receives the output data packet, parses the content, and presents the information to the user via the application interface. The input is the packet received from the server. The terminal displays proposals, documents, progress reports, and notifications in an organized and user-friendly manner. The output is an enhanced user experience, allowing the user to act upon the system’s suggestions and continue the iterative business planning process.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern business environments, particularly for emerging enterprises, it is challenging to manage and analyze a vast amount of information, optimize resource allocation, make strategic decisions, match investors, and provide personalized support based on users' emotional states. Traditional information management systems lack the capability to integrate external market data, process user emotions, and dynamically generate strategies and proposals tailored to individual users in real time. Therefore, there is a need for an advanced support system that enables comprehensive business assistance, combining intelligent data processing, trend analysis, and personalized feedback, all adapted to the user's situational and emotional context.

The specific processing by the specific processing unit 290 of the data processing device 12 in Example 2 is realized by the following means.

The present invention provides a server comprising a processor configured to acquire and store information from both internal and external information sources, generate prompt sentences reflecting user intent, project progress status, and emotional state, and input such prompts to a generative intelligent processing model to obtain new business proposals, support strategies, resource optimization plans, and risk mitigation measures, with outputs personally tailored to each user's emotional context. This enables efficient and adaptive business management support, real-time strategic proposal delivery, optimal resource allocation, and user-specific feedback adapted to the user's emotional and operational state.

The term “information storage unit” refers to a data storage means, such as a database or memory device, that is configured to store various types of information used and generated by the system.

The term “external information source” refers to any data provider outside the system, including public databases, market information services, social media platforms, or news websites, from which information can be collected or received.

The term “prompt sentence” refers to a natural language text or query generated by the system, which conveys specific user intent, progress status, and emotional state to a generative intelligent processing model for the purpose of obtaining relevant information.

The term “generative intelligent processing model” refers to an artificial intelligence model equipped with natural language processing capability, configured to accept prompt sentences and output new business proposals, management strategies, or other types of support information.

The term “user input intent” refers to the objective or purpose expressed by a user through their input, indicating the desired action, focus area, or business goal they wish the system to address.

The term “progress status” refers to the current state or phase of a business activity, including completed tasks, ongoing developments, milestones met, and outstanding objectives.

The term “emotional state information” refers to data representing the user’s psychological or emotional condition, such as levels of motivation, stress, satisfaction, or engagement, as detected or reported through the system.

The term “resource allocation optimization information” refers to recommendations or plans generated by the system for the optimal distribution and usage of available resources, including personnel, time, and financial assets, within a business activity.

The term “fundraising support information” refers to information, advice, or action plans generated by the system to assist the user in obtaining financial backing or investment for a business activity.

The term “sales promotion planning information” refers to information or strategies generated by the system aimed at supporting marketing, advertising, or sales campaigns for a business activity.

The term “development process management information” refers to guidance, metrics, or progress updates generated by the system for managing the phases and tasks involved in developing a product or service.

The term “risk mitigation information” refers to information or strategies generated by the system that identify potential risks and recommend methods to reduce or manage those risks.

The term “user terminal” refers to a computing device, such as a smartphone, tablet, or computer, used by the user to interact with the system and receive information.

The term “personalized support” refers to assistance, advice, or content generated by the system that is specifically tailored to the individual user’s context, needs, or emotional state.

One embodiment of the present invention is directed to a system comprising a server equipped with a processor that coordinates the flow of business support information between users and an intelligent processing infrastructure. The server interacts with various hardware and software components, including relational databases, cloud computing resources, user terminals such as smartphones, tablets, or computers, and application interfaces for both user interaction and external data acquisition.

The server is configured to store diverse types of information in an information storage unit, which may be realized through a general-purpose relational database management system (for example, a structured query language (SQL) based database), or a distributed cloud database. The system collects data from both local user input and external information sources. External information sources may include public databases for business and market data, internet-based application programming interfaces (APIs) providing real-time industry statistics, and social media feeds. Specific software tools suitable for these tasks include data collection libraries (for example, Scrapy for web crawling and Requests for API interaction in Python environments).

The user's terminal, which may be a conventional smart device, provides a graphical interface or web-based form that allows the user to enter business project data, goals, and emotional state information. The terminal transmits the entered data securely to the server via protocols such as HTTPS. The data are structured and stored in the server's information storage unit for subsequent processing.

The server utilizes algorithmic data processing pipelines implemented in software frameworks such as Python, using data analysis libraries like Pandas for preprocessing, cleaning, and normalization of collected business and market information. The server performs machine learning-based trend analysis using platforms such as TensorFlow or Scikit-Learn, which process the data to identify patterns or emerging opportunities in the relevant market sectors.

Based on the results of this analysis, the server generates a prompt sentence that reflects the user's intent, the current progress of their business activities, and their emotional state. This prompt is constructed in natural language and designed to deliver complete contextual information to a generative intelligent processing model, such as a natural language processing-based large language model (e.g., a language model similar to GPT-4 or other transformer-based AI models).

The prompt sentence is input to the generative intelligent processing model, which outputs support information including but not limited to new business proposal ideas, progress management recommendations, resource allocation optimization plans, fundraising strategies, sales promotion strategies, development process management suggestions, and risk mitigation advice. These generated outputs are evaluated, structured, and stored by the server.

The server further analyzes the user's emotional state, which is gathered either directly from user input or inferred from communication context, utilizing sentiment or emotion analysis engines (for instance, machine learning models in Scikit-Learn or third-party emotional analysis APIs). The system adapts the notifications, recommendations, and information delivered to the user's terminal based on this analyzed emotional state, providing personalized support tailored to the user's current situation.

The user receives the server's feedback and strategic proposals through their terminal in an organized format such as a dashboard, notification messages, or detailed reports. The user may also interact with these proposals by accepting recommendations, requesting clarifications, or entering new objectives.

A concrete example involves a user who inputs a business plan to launch a new healthcare wearable product and indicates concern about market competition. The server collects up-to-date healthcare industry data via external APIs, processes trend analysis using TensorFlow, and generates a prompt sentence as follows:

“Given recent data showing increased interest in telemedicine devices, and considering a startup plan for a stress-relief wearable targeting remote workers - please propose three business launch strategies. Evaluate their competitive advantages and project potential market impact.”

Based on this prompt, the generative intelligent processing model outputs a series of proposals. The server selects and tailors these proposals according to the user’s emotional state, as detected from input data or user responses, and communicates these personalized strategic recommendations to the user terminal.

In this manner, the system enables effective, adaptive business support, leveraging advanced data processing, machine learning, artificial intelligence, and emotional analysis technologies in a unified platform, facilitating optimal business outcomes in real time according to user needs and emotional context.

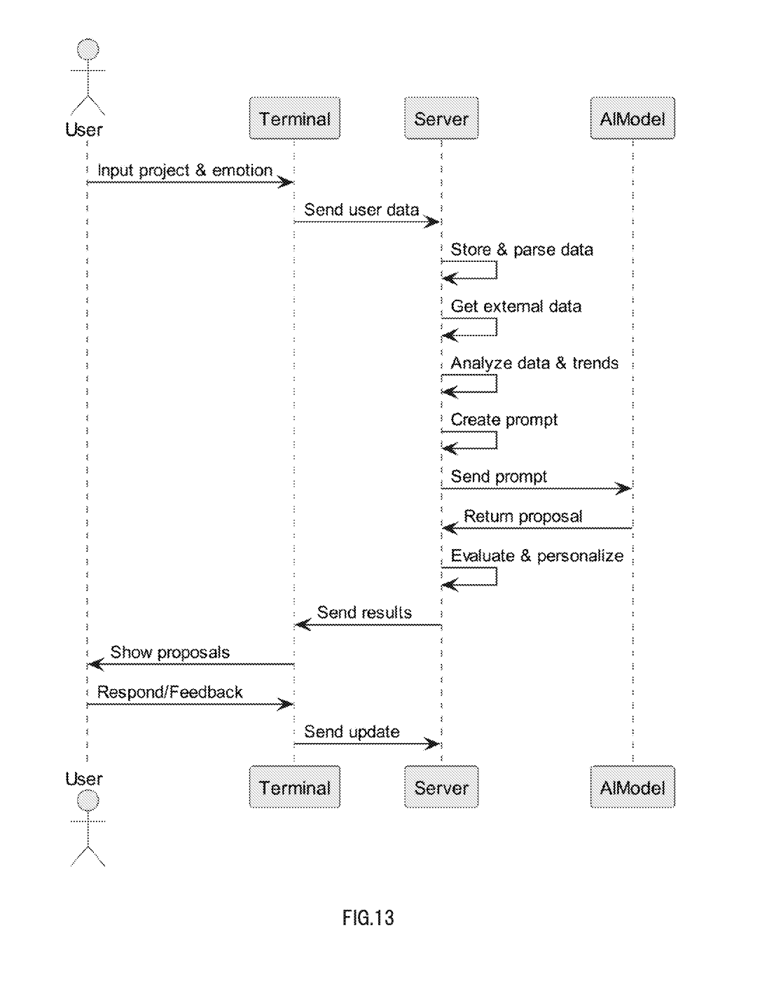

The following describes the processing flow using FIG. 13.

### Step 1:

The user accesses an application or web form on the terminal and inputs business project data, such as the project description, target market, goals, and current emotional state. The terminal validates the input, structures the data as a JSON object, and encrypts it for secure transmission.

Input: user-entered text data.

Output: structured and encrypted user data sent to the server.

### Step 2:

The server receives the user data and stores it in a database for persistent management. The server parses the relevant fields (e.g., business domain, goals, emotional state).

Input: structured user data.

Output: parsed user and project information stored in the information storage unit.

### Step 3:

The server uses the parsed domain and project information to retrieve external market and business data from public APIs, industry databases, and news sources. The server applies data collection tools, formats the acquired data, and timestamps each source before storage.

Input: user project information and external data queries.

Output: cleaned and aggregated external information stored in the database.

### Step 4:

The server preprocesses the collected external data using data cleaning and normalization (removing duplicates, standardizing terms, etc.) with Pandas.

Input: raw external data.

Output: cleaned and normalized market data.

### Step 5:

The server executes trend and pattern analysis on the preprocessed data using machine learning libraries such as TensorFlow or Scikit-Learn. The server identifies key trends, forecasts market potential, and generates a summary report.

Input: normalized market data.

Output: quantitative trend indicators and textual trend summaries.

### Step 6:

The server combines the user project goals, progress, and emotional state with the trend analysis results to generate a prompt sentence in natural language. This prompt is designed to communicate the business context to a generative AI model.

Input: user data and trend summaries.

Output: a natural language prompt sentence prepared for AI processing.

### Step 7:

The server sends the prompt sentence and associated context to a generative AI model (e.g., a large language model). The model processes the input and generates business strategies, proposals, suggestions, or other requested information.

Input: natural language prompt sentence.

Output: AI-generated support information, including new business ideas and management recommendations.

### Step 8:

The server applies post-processing analysis to evaluate the generated outputs using additional algorithms (e.g., scoring business ideas for feasibility and impact). The server organizes the outputs and stores them in the database.

Input: AI-generated support information.

Output: ranked and structured strategic business outputs.

### Step 9:

The server performs emotion analysis on the user’s current state using sentiment analysis tools or emotion AI APIs. The server determines the appropriate feedback style (such as simplified instructions for anxious users or detailed reports for confident users).

Input: user emotional state data.

Output: recommendations for personalized information delivery.

### Step 10:

The server transmits the evaluated, emotionally-adapted outputs back to the terminal. The terminal renders dashboards, notifications, and actionable feedback tailored to the user's needs and emotions.

Input: personalized business outputs.

Output: displayed guidance, proposals, and notifications to the user.

### Step 11:

The user reviews the provided results and may interact by accepting, rejecting, or requesting clarification on specific recommendations. The terminal captures these actions and sends them to the server for further processing, enabling iterative support.

Input: user reactions and decisions..

Output: updated user intent and feedback for subsequent processing cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional business support systems provide generic assistance without appropriately responding to the emotional state of users, making it difficult to reduce stress or anxiety felt by the user. Moreover, existing systems cannot flexibly provide proposals and guidance that are customized according to the user's psychological condition, nor can they automatically adapt business support content, progress management, or risk assessment based on dynamic environmental and emotional factors. There is also insufficient integration of real-time market trends, resource allocation optimization, and risk mitigation, especially when these must be tailored in response to psychological data and external information sources. Therefore, an improved system is needed for supporting business development and project management in a way that dynamically adapts recommendations, resource allocations, and risk responses according to both business context and user psychological status.

The specific processing by the specific processing unit 290 of the data processing device 12 in Application Example 2 is realized by the following means.

The present invention provides a server comprising a processor configured to store information, generate a prompt sentence based on user event data and psychological information as well as stored information, input the prompt sentence to a generative AI model to obtain business-related proposals and management information, present such information to the user with adaptation to the user’s psychological status, collect external trend, industry, investment, and emotion analysis information, monitor project progress, optimize resource allocation, and utilize artificial intelligence to predict risk factors and provide risk mitigation proposals. This enables dynamic and personalized business support in which proposals, progress tracking, resource management, and risk mitigation are automatically customized in real time to the business context and the psychological state of the user, thereby improving user experience, well-being, and project efficiency.

The term “information storage unit” refers to a data storage apparatus or memory device configured to electronically store various types of information including business-related, market-related, user-input, or psychological data.

The term “event information” refers to data pertaining to occurrences, activities, or specific incidents related to a business, project, or user input that are relevant to business support and management.

The term “psychological information” refers to data indicating or representing the emotional, mental, or psychological state of a user, such as stress, fatigue, anxiety, motivation, or satisfaction, acquired through user input or analysis.

The term “prompt sentence” refers to a textual instruction or query generated for the purpose of eliciting a specific response or output from a generative AI model, which typically combines user data and contextual information.

The term “generative AI model” refers to an artificial intelligence model, such as a large language model or machine learning model, capable of creating natural language responses, proposals, or solutions in response to input information and prompts, by performing natural language processing.

The term “new business information” refers to generated data or suggestions relating to novel business ideas, expansion strategies, or startup opportunities.

The term “workflow information” refers to data related to the management, scheduling, and optimization of processes and tasks required for executing a project or business operation.

The term “fundraising support information” refers to suggestions, plans, or data generated for supporting the user’s efforts in obtaining financial resources or investments for business activities.

The term “distribution promotion information” refers to generated recommendations or strategies aimed at increasing product or service awareness, market reach, or sales performance.

The term “process improvement information” refers to suggestions or data generated for enhancing, optimizing, or streamlining steps, operations, and procedures within business or project activities.

The term “risk avoidance information” refers to data, proposals, or strategies generated to help the user identify, assess, and minimize potential risks related to business or project activities.

The term “trend information” refers to data reflecting ongoing or emerging movements, patterns, or directions within a relevant market or industry, which may affect business decisions.

The term “industry information” refers to data and knowledge relating to specific business sectors, including competitor analysis, technological advancements, and regulatory updates.

The term “investment opportunity information” refers to data or analysis relating to potential sources of funding, partnership possibilities, or favorable conditions for financial investment within a business context.

The term “emotion analysis result” refers to the outcome of analyzing user data to identify and quantify the user’s emotional states using artificial intelligence or algorithmic methods.

The term “operation terminal” refers to a user-operated electronic device, such as a smartphone, tablet, or computer, through which information is input, received, or displayed in the system.

The term “resource allocation” refers to the assignment or distribution of available assets, time, or human resources within a project or business in order to optimize project execution and efficiency.

The term “risk mitigation proposal” refers to generated advice or strategies designed to reduce, control, or manage possible risks in business or project operations.

One embodiment of the invention will now be described in detail below. The system comprises a server equipped with a processor, memory (such as solid-state drive or hard disk), network interface, and associated hardware resources. The server runs a server-side operating system, for example, a Linux-based OS, and hosts application software implemented using programming languages such as Python, with frameworks such as Django or Flask for API management. The system also includes at least one user terminal, such as a smartphone, tablet, or computer, which is operated by the user, and can be implemented using commercial devices running Android, iOS, or other operating systems. The user terminal may include a dedicated application for data entry and system interaction. The server is configured to store information in an information storage unit. This storage includes business-related, market-related, user-supplied event information, and psychological information. The server retrieves and stores external information, such as market trends and industry data, from public or commercial databases accessible over the Internet. Tools for such data acquisition may include publicly available APIs or web scraping software utilizing libraries such as requests and BeautifulSoup.

The user inputs event information and psychological information through input forms provided on the terminal application. Event information may include business ideas, project statuses, goals, or concerns, while psychological information may relate to user-reported stress, fatigue, or motivation. The terminal application transmits these data entries securely to the server over HTTPS.

The server employs a prompt generator module to automatically create prompt sentences by combining user-input event and psychological information together with stored business or market information. These prompt sentences are designed to elicit specific and informative responses from a generative AI model. The generative AI model may be implemented, for example, as a large language model deployed locally or accessed via a cloud-based API.

For instance, a typical prompt sentence generated by the server may read:

"Analyze the user's current emotional state and business objectives, and provide a customized action plan and risk assessment suitable for the ongoing project."

Another example is:

"The user is experiencing fatigue and stress related to upcoming deadlines. Based on current market trends in the related industry, generate three prioritized actions to help the user progress efficiently and improve psychological well-being."

The server sends the prompt sentence to the generative AI model, such as GPT-4 provided by a third-party cloud service or a model implemented using open-source frameworks like Hugging Face Transformers. The generative AI model processes the prompt using natural language processing and generates at least one of the following: new business information, workflow advice, fundraising strategies, distribution promotion recommendations, process improvement actions, or risk avoidance proposals.

The generated information is then packaged by the server for presentation. The server tailors the presentation style, such as information granularity, display order, or interaction mode, based on the user's psychological information. The server transmits the output, along with any relevant feedback or emotional guidance, to the user terminal.

On the user terminal, the application displays the received proposals, guidance, risk reports, and other information with an intuitive user interface. The user can interactively review, accept, or provide feedback on the proposals. If the terminal is integrated with a robot or other output device, supportive behavior, such as conversational encouragement, can be triggered based on the user's emotional state and the AI-generated output.

During operation, the server continuously collects and analyzes additional information from external sources. This may include trend data, industry reports, emotional analysis results from AI-based emotion recognition modules, and investment opportunity data. This information is integrated into subsequent prompt generations and proposal designs.

The server further monitors project progress by analyzing activity logs and operational data from user terminals or connected project management applications. Resource allocation is optimized in real time based on this monitoring. Risk analysis modules implemented on the server predict potential hazards using machine learning algorithms for anomaly detection, and propose mitigation strategies that are automatically communicated to the user.

Through this architecture, the invention enables dynamic and highly personalized support for business management and project execution, with automatic adaptation to both real-time business context and user psychological state. The combination of user-supplied data, external market information, and AI-guided natural language generation ensures that the user receives concrete, context-aware, and emotionally responsive advice, thereby supporting superior user experience, risk management, and business efficiency.

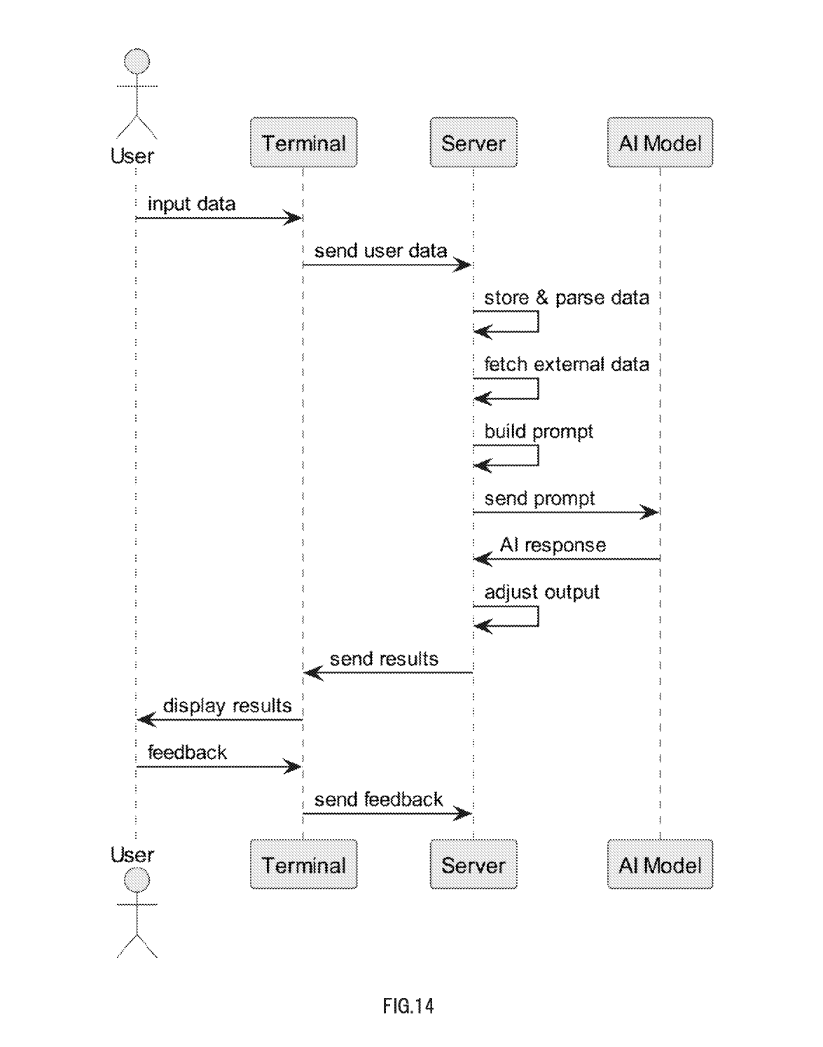

The following describes the processing flow using FIG. 14.

### Step 1:

The user operates the terminal to input event information, such as project descriptions, business goals, current progress, and optionally, psychological information, such as stress level or motivation. The terminal presents a user interface form for data entry. The terminal validates the input and, upon user confirmation, formats the data into a structured format (such as JSON) and transmits it securely to the server via HTTPS.

Input: User-entered event and psychological information.

Output: Formatted, validated data package transmitted to the server.

### Step 2:

The server receives the input data and stores it in the information storage unit. The server parses the data, extracts key entities (such as tasks, deadlines, and emotional indicators), and associates them with the user session in a relational database. Additionally, the server may timestamp the incoming data and categorize it by context type (e.g., project phase, user state).

Input: Structured user data from terminal.

Output: Parsed, stored, and categorized data in the server database.

### Step 3:

The server retrieves external data relevant to the user’s project, such as market trends, industry reports, investment opportunities, and competitors’ activities. The server uses APIs, web scraping utilities, or database queries to gather this information. The data is cleaned, standardized, and indexed using data processing software (such as pandas in Python).

Input: Project context and keywords from stored user data.

Output: Standardized and indexed external data relevant to the user’s project.

### Step 4:

The server collects both the newly received user data and the relevant external data, and uses a prompt generator module to construct a prompt sentence designed for the generative AI model. This prompt incorporates the user’s current psychological and project status, plus newly analyzed environmental context.

Input: Stored user data and standardized external data.

Output: Contextualized prompt sentence for the generative AI model.

Step 5:

The server inputs the prompt sentence into the generative AI model (for example, via an API call to a language model). The generative AI model processes the prompt using natural language processing and generates output such as a business proposal, workflow recommendation, risk assessment, or resource allocation plan.

Input: Prompt sentence from prompt generator.

Output: Generated natural language response with actionable business and management suggestions.

### Step 6:

The server receives the generated output, post-processes the content to filter or adjust its details according to the user’s psychological information, and translates key parts into structured items for display. For example, if the user is stressed, the server simplifies language and highlights key priorities.

Input: Raw generative AI model output and user’s psychological information.

Output: Refined, psychologically-adjusted suggestions ready for user presentation.

### Step 7:

The server transmits the finalized suggestions, assessments, or action plans to the terminal. The terminal receives this information and displays it via a user-friendly interface, using widgets such as cards, progress bars, and notifications. If emotional support is needed, the terminal may trigger a supportive message or a conversation prompt.

Input: Psychologically-adjusted proposals and recommendations from the server.

Output: Interactive, context-sensitive guidance and support presented on the terminal to the user.

### Step 8:

The user reviews, accepts, or provides feedback on the suggestions via the terminal interface (for example, by clicking on action buttons, typing comments, or rating responses). The terminal collects this feedback and sends it to the server for further optimization and personalized adaptation in future iterations.

Input: User actions and feedback regarding displayed suggestions.

Output: Feedback data sent to the server for ongoing system learning and improvement.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

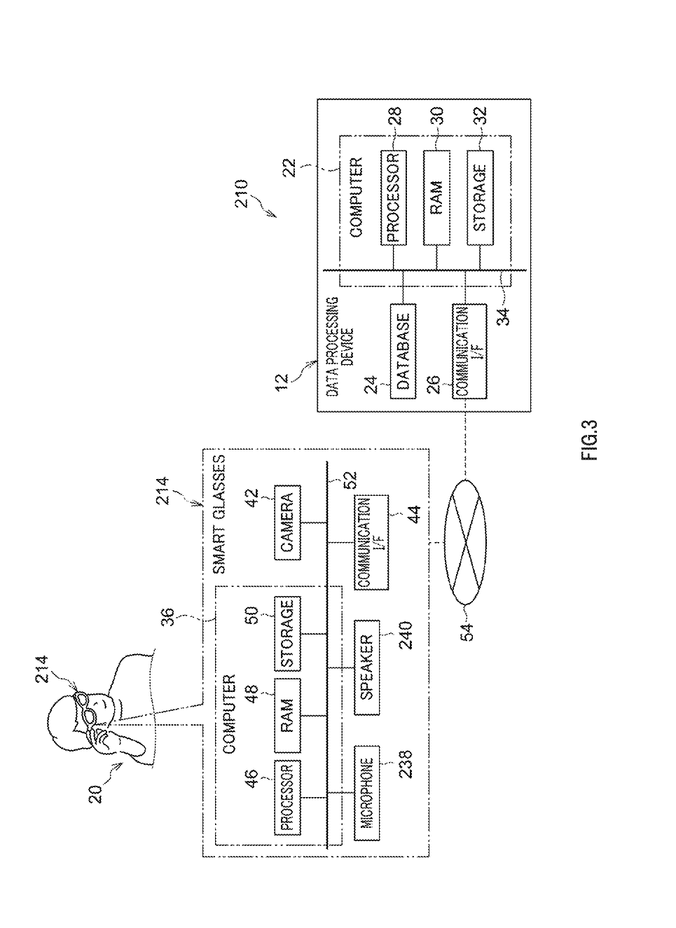

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

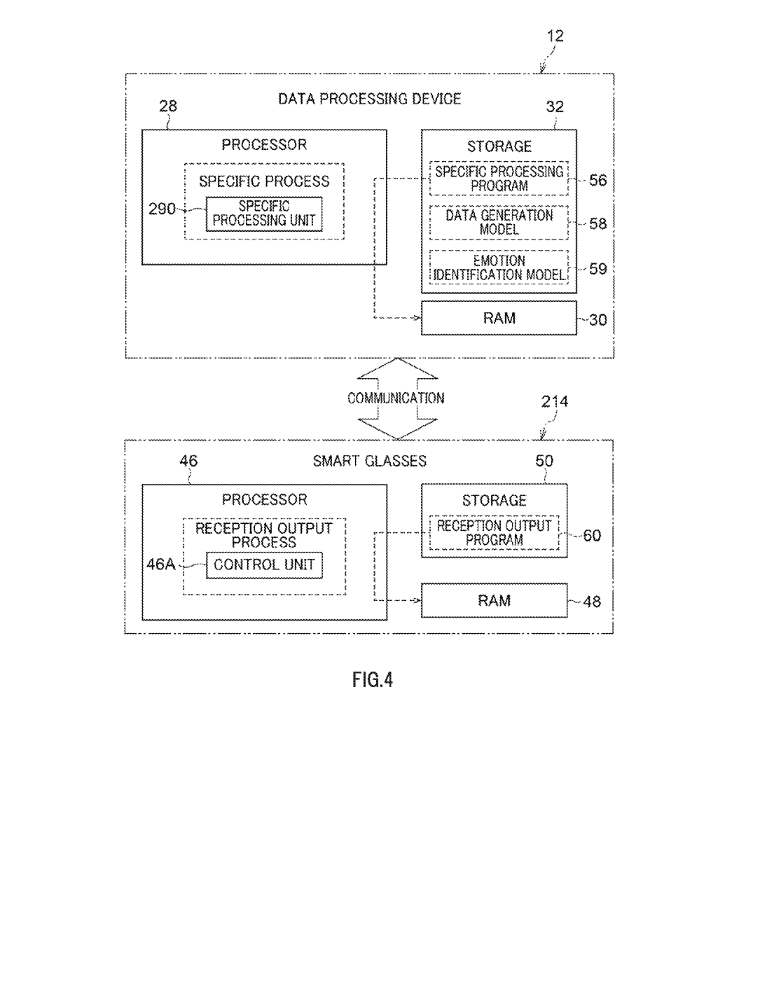

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

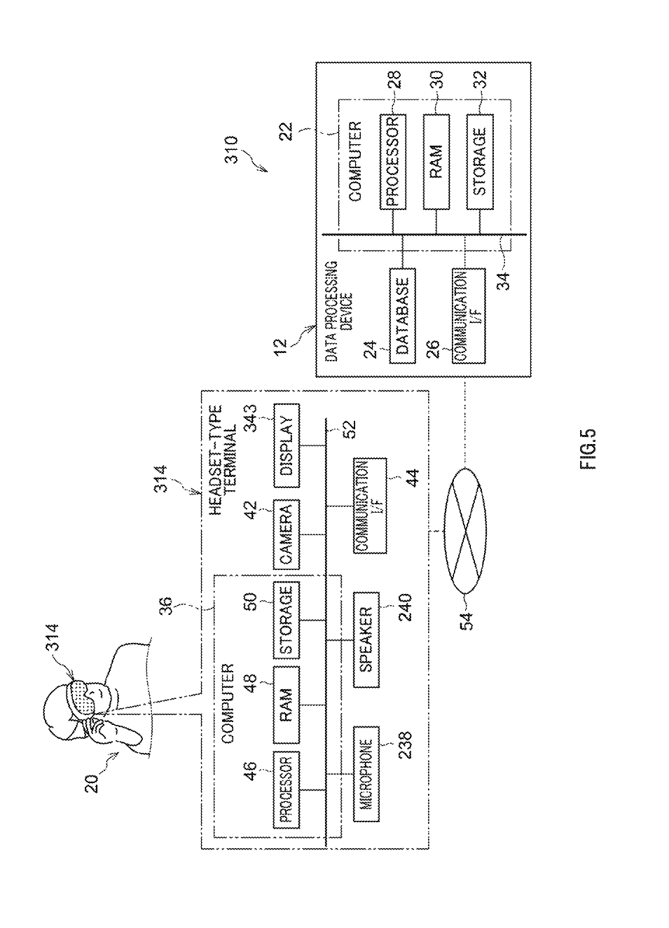

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

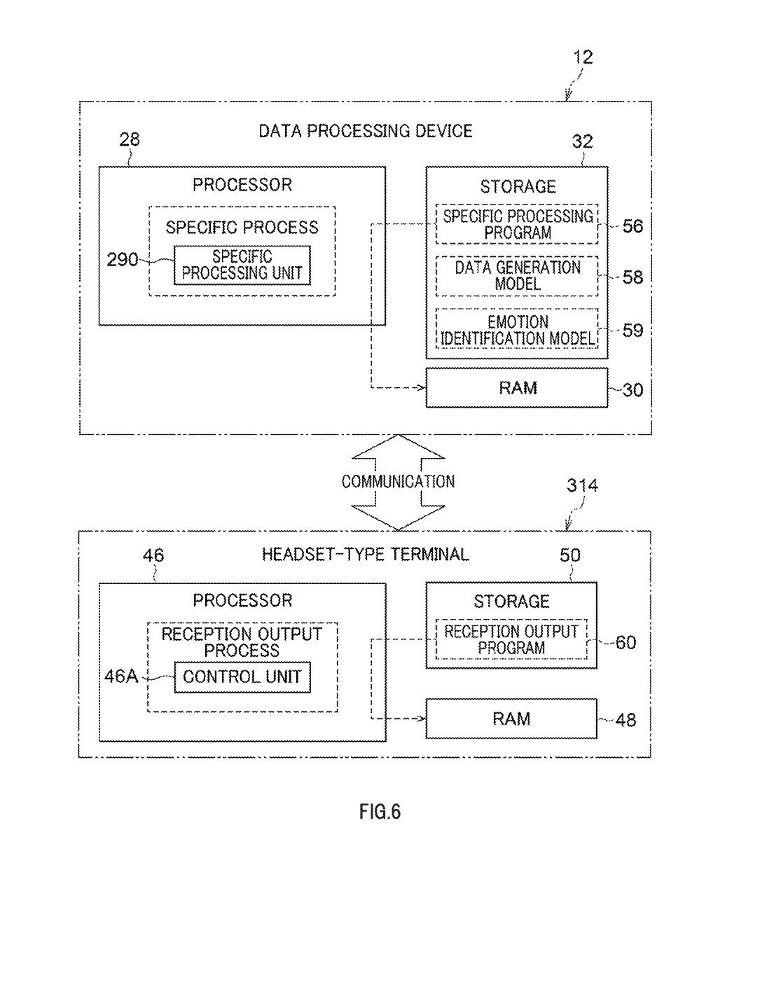

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

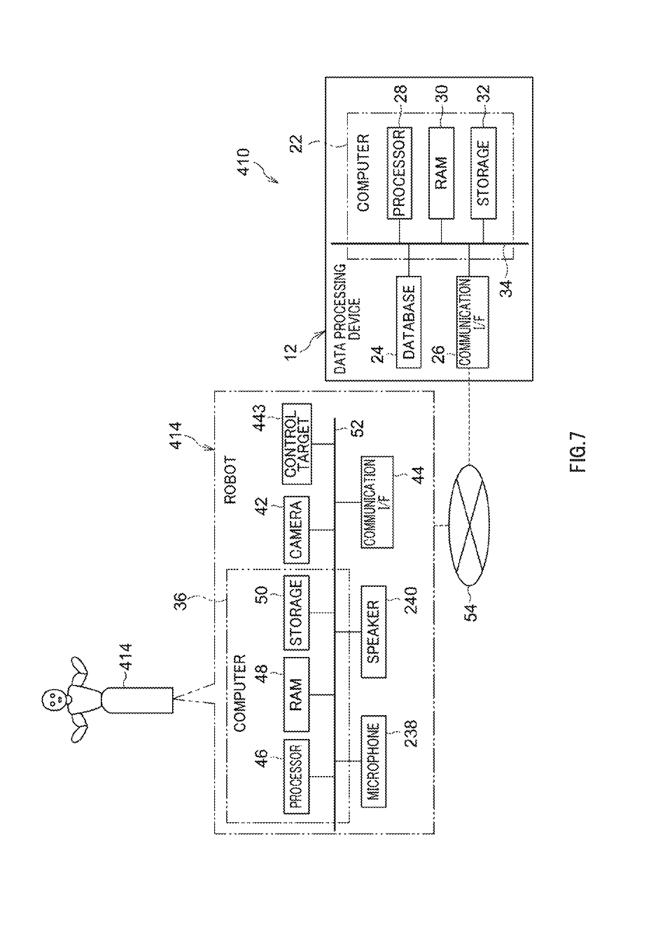

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

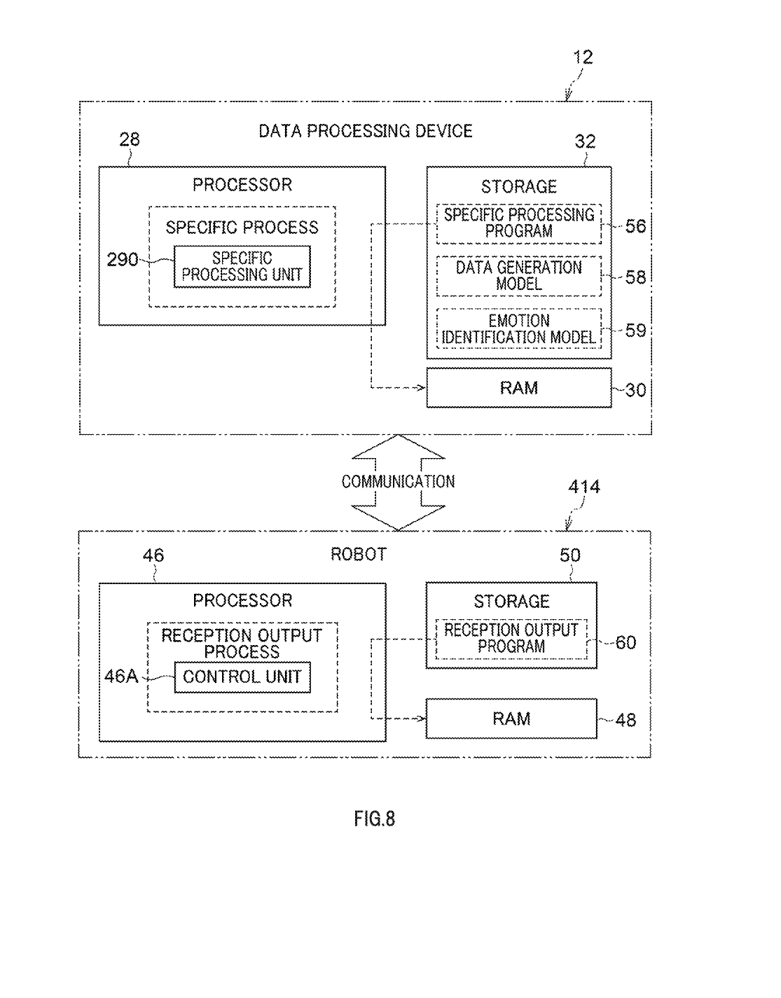

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

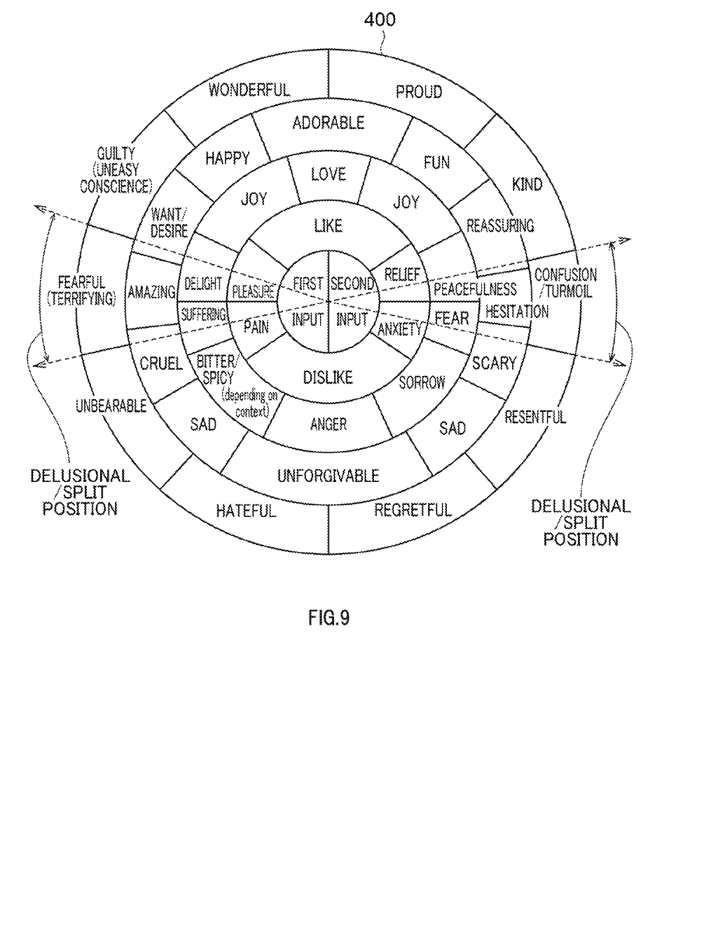

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

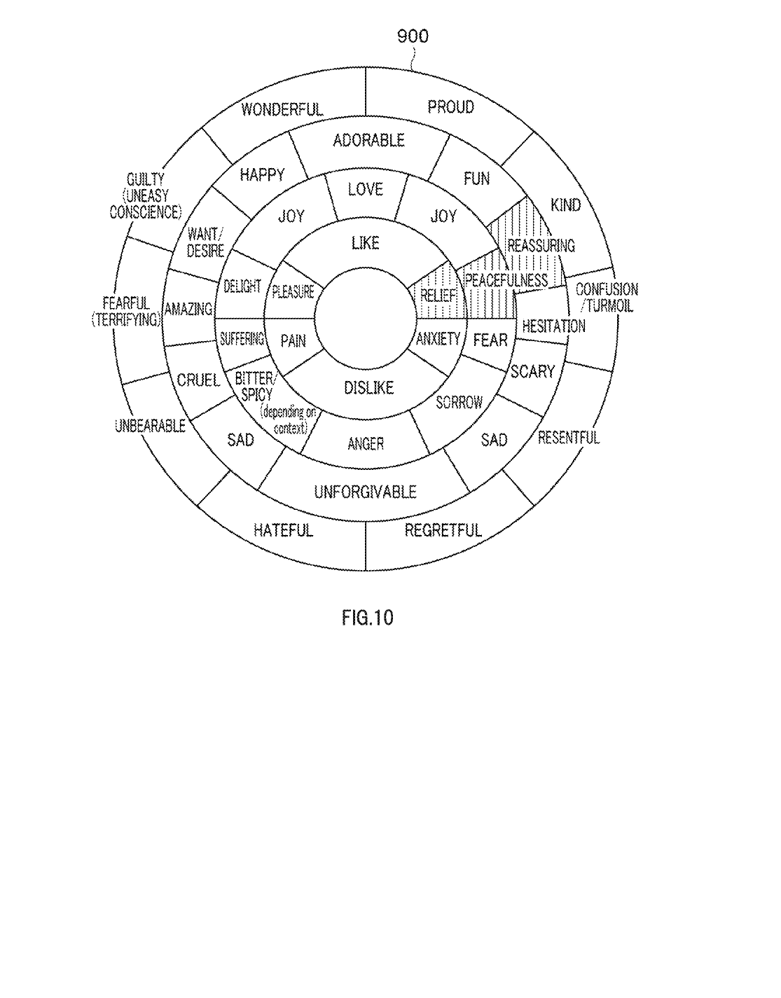

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

store information in an information storage unit,

generate a prompt sentence automatically based on the information stored in the information storage unit, the prompt sentence being adapted as input to an external or internal generative machine learning model that performs natural language processing,

input the prompt sentence generated by the prompt sentence generation unit into the generative machine learning model, obtain a response generated by the model, and convert the response into structured data or displayable information,

in response to a user request received from a terminal device, provide the information obtained by the generative response acquisition unit to the user via the terminal device,

manage, using an interaction history management unit, multiple user requests and received responses, so as to refer to and utilize prior responses or requests when generating additional information or generating new prompt sentences for re-querying, in the event of further user requests,

and support, by a terminal support unit operating on the terminal device, transmission and reception of information as well as dynamic display and operation acceptance for acquired response information on the terminal device.

### Supplementary 2

The system according to supplementary 1,

wherein the processor is configured to

automatically generate an adaptive-format prompt sentence by template processing, based on context information, attribute information, or numerical data retrieved from stored information, in order to improve the output accuracy and relevance of the generative machine learning model.

### Supplementary 3

The system according to supplementary 1,

wherein the processor is configured to

manage a history of multiple user requests and generated response information by the interaction history management unit, and to perform continuous inquiry processing as well as reuse of acquired information or addition of newly obtained information.

### Application Example 1

### Supplementary 1

A system comprising a processor,

wherein the processor is configured to

store information in a storage unit,

receive business concept information and emotional state information inputted by a user through an input reception unit,

generate a prompt sentence in natural language based on market-related information or business-related information stored in the storage unit and information inputted by the user,

input the prompt sentence into a generative artificial intelligence model capable of natural language processing, and obtain at least one of new business proposal information, progress management information, resource allocation optimization information, funding support information, advertising activity information, development process improvement information, or risk avoidance information from the generative artificial intelligence model,

provide, in real time or sequentially, the obtained information to a user terminal via a presentation unit,

and analyze the emotional state information inputted by the user to adjust the content or form of proposals and notifications provided by the system according to the analysis result.

### Supplementary 2

The system according to supplementary 1,

wherein the processor is configured to

include trend information or consumer preference information in the prompt sentence based on market-related information so that the generative artificial intelligence model generates advertising activity information or promotional information.

### Supplementary 3

The system according to supplementary 1,

wherein the processor is configured to

personalize information provided by the presentation unit based on analysis of emotional state information inputted by the user.

### Example 2

### Supplementary 1

A system comprising a processor,

wherein the processor is configured to

store information in an information storage unit,

generate a prompt sentence based on the information stored in the information storage unit and information acquired from external information sources, the prompt sentence including user input intent, progress status of a business activity, and emotional state information,

input the prompt sentence into a generative intelligent processing model having natural language processing capability, and acquire from the generative intelligent processing model at least one of new business proposal information, progress management support information, resource allocation optimization information, fundraising support information, sales promotion planning information, development process management information, or risk mitigation information,

provide, based on the information thus acquired, updates regarding progress status, strategic proposals, and notifications and support contents personalized according to the user's emotional state to a user terminal,

and analyze the user's emotional state and adaptively adjust the contents provided by the information providing function according to the analyzed emotional state.

### Supplementary 2

The system according to supplementary 1, wherein the processor is configured to generate the prompt sentence based on market-related information and trend analysis information acquired from external information sources and user emotional state information, and cause the generative intelligent processing model to generate sales promotion planning information adapted to the user's emotional state.

### Supplementary 3

The system according to supplementary 1,

wherein the processor is configured to

extract potential risk factors from the information stored in the information storage unit and the information acquired from external information sources in order to generate risk mitigation information, and modify the prompt sentence based on the extracted potential risk factors and the user's emotional state.

### Application Example 2

### Supplementary 1

A system comprising a processor,

wherein the processor is configured to

store information in an information storage unit;

generate a prompt sentence for instructing the generation of support strategy information based on input information, including event information and psychological information obtained from a user, and the information stored in the information storage unit;

input the prompt sentence into a generative AI model performing natural language processing and obtain from the generative AI model at least one of new business information, workflow information, fundraising support information, distribution promotion information, process improvement information, or risk avoidance information;

present the information obtained by the generative AI model and the psychological information to a user via an operation terminal, adjusting the granularity, order, or mode of presentation based on the psychological information;

collect trend information, industry information, investment opportunity information, and emotion analysis results from external information sources, and reflect the collected information in the operations of the generative AI model and presentation functions;

monitor progress of ongoing activities, analyze activity records and operational information, and optimize execution status and resource allocation; and

predict risk factors and generate risk mitigation proposals using artificial intelligence, and present risk information and response proposals to the user.

### Supplementary 2

The system according to supplementary 1,

wherein the processor is configured to

include trend information, psychological information, and market information in the prompt sentence so that the generative AI model generates distribution promotion information, and adapt the content or presentation method of the distribution promotion information based on the psychological information.

### Supplementary 3

The system according to supplementary 1,

wherein the processor is configured to

extract potential risk factors from the information stored in the information storage unit and external information acquired by the collection functions, generate a prompt sentence based on the risk factors, input the prompt sentence to the generative AI model, and obtain risk mitigation proposals from the generative AI model.

What is claimed is:

1. A system comprising a processor,
wherein the processor is configured to:
retain market-related information or business-related information,
generate a prompt sentence that instructs generation of strategic information concerning establishment or growth of a business entity based on the market-related information or business-related information stored in the information retaining means,
input the prompt sentence to a generative AI model that performs natural language processing and acquires at least one of new business proposal information, progress management information, funding support information, sales promotion information, development process improvement information, or risk avoidance information for the business entity from the generative AI model, and
present the information acquired by said generation means to a user.

2. The system according to claim 1, wherein the processor is configured to generate the prompt sentence in which include trend information based on the market-related information, so that the generative AI model generates the sales promotion information.

3. The system according to claim 1, wherein the processor is configured to extract potential factors from the market-related information or the business-related information to generate the risk avoidance information and revise the prompt sentence based on the potential factors.
